(19) United States
(12) Patent Application Publication
(10) Pub. No.: US 2025/0176564 A1
(43) Pub. Date: Jun. 5, 2025

(54) PORTABLE BAKING OVEN

(71) Applicant: WH Products, LLC, Columbus, OH (US)

(72) Inventors: Michael R. Giebel, Joplin, MO (US); Alexandra Devi Upadhyaya, Louisville, KY (US)

(73) Assignee: WH Products, LLC, Columbus, OH (US)

(21) Appl. No.: 18/965,563

(22) Filed: Dec. 2, 2024

Related U.S. Application Data
(60) Provisional application No. 63/604,485, filed on Nov. 30, 2023.

(51) Int. Cl. A21B 1/44; A21B 1/28; A21B 1/52

(52) U.S. Cl. CPC A21B 1/44; A21B 1/28; A21B 1/52

(57) ABSTRACT

A portable baking oven includes a housing defining a baking chamber and a baking chamber opening of sufficient size to allow a baking item to pass therethrough. A baking stone is disposed in the housing and a mechanically wound spring motor rotates the baking stone.

### CROSS-REFERENCE TO RELATED APPLICATIONS

This application claims the benefit of U.S. Provisional Application No. 63/604,485 filed Nov. 30, 2023, entitled Portable Baking Oven, the disclosure of which is hereby incorporated by reference herein in its entirety.

### FIELD OF THE INVENTION

Embodiments of the present invention relate to food cooking appliances.

### BACKGROUND OF THE INVENTION

Outdoor cooking has become very popular, and accordingly the need for portable appliances to facilitate outdoor cooking has increased. As part of this trend, a desire has developed to practice all forms of cooking outdoors, including baking. A number of different appliances are currently available to bake food, particularly pizza, outdoors. In order to bake or cook pizza, the baking chamber is preferably very hot and traditionally the best pizza ovens have been constructed of brick which enables the baking chamber to be maintained at very high temperatures. Cooking temperatures above 400F degrees are normally required, and preferable cooking temperatures may range as high as 700F-900F degrees or even higher. Furthermore, it is preferable to cook pizza on a stone or stone-like surface because the stone efficiently conducts and holds heat, which may keep the oven temperature steady even when a cold ingredient (such as an uncooked pizza) is introduced. A stone cooking surface not only helps the pizza cook more evenly, but also allows the bottom to get crisp. A crisp outer crust is considered essential for a quality pizza.

Cooking appliances require some form of power and/or fuel to generate the heat required for cooking. With respect to outdoor ovens in particular, it may be difficult to provide sufficient power to generate the high temperatures desired to cook pizza. Power may also be needed to rotate a pizza stone relative to a heat source when using a compact portable outdoor oven to cook pizza. However, in order to be truly portable, an oven should not rely solely on alternating current (AC) as a power source. Conversely, the power requirement of traditional gas heating elements capable of generating the desired temperatures for cooking pizza may require relatively large supplies of gas fuel, e.g., twenty-pound propane cylinders. Further, non-electric heating elements, such as conventional propane burners, may be prone to uneven heating and poor reheating characteristics when tasked with heating a series of cold items, one after the other. As a result of these challenges, manufacturers have struggled to provide an affordable and truly portable oven for cooking pizza that is able to generate and maintain the desired cooking temperatures. Manufacturers have also found it difficult to provide an affordable and compact portable oven for cooking pizza that distributes heat in a manner that produces a crisp outer crust without burning portions of the pizza.

In light of the foregoing challenges, there is a need for an affordable portable pizza oven that is untethered to a continuous supply of AC electrical power. Portable ovens including an onboard manually wound helical spring assembly to power a rotating baking stone are needed to provide improved portability.

There is a need also for a portable pizza oven that is relatively light, compact, and capable of being used safely on a table top surface. In particular, there is a need for a compact oven that is still capable of cooking a pizza up to approximately sixteen (16) inches in diameter to provide sufficient amounts of food for several people at a time.

There is a need also for a portable pizza oven that is able to generate and sustain the high temperatures required for cooking pizza. A preferred oven should be able to maintain required cooking temperatures while cooking a series of pizzas. As such, a preferred portable pizza oven should be capable of more quickly rebounding to a desired cooking temperature when tasked with heating a series of cold items, one after the other. As a result of maintenance of high temperatures, cooking times preferably may be under ten (10) minutes, more preferably under seven (7) minutes, and even more preferably about five (5) minutes.

There is a need also for a portable pizza oven that improves the ease with which a pizza may be quickly and evenly cooked to have a crisp outer crust without burning. In particular, there is a need for an oven that applies heat in a manner that crisps all portions of the crust evenly, including the very center of the pizza and the outer edge.

There is a need also for a portable pizza oven that is esthetically pleasing and mimics the look and feel of a traditional brick oven. In particular, because pizza ovens must be maintained at such a high temperature, there is a need for an oven that can quickly acquire cooking temperature and maintain it without requiring the user to open and close a baking chamber door which would necessarily be very hot to the touch.

There is a need also for a portable pizza oven that is designed to be used safely outdoors without generating excessively high outer surface temperatures.

There is a need also for a portable pizza oven that efficiently manages the collection of grease or other food particles that fall from the pizza during cooking or during the process of placing the pizza in, and removing the pizza from, the oven. Still further, there is a need for a portable pizza oven that is easily cleaned after use.

### OBJECTS OF THE INVENTION

Accordingly, it is an object of some, but not necessarily all embodiments of the present invention to provide an affordable portable pizza oven that is untethered to a continuous supply of AC or battery electrical power to rotate a pizza stone. Some embodiments of the present invention may include a manually wound helical spring assembly capable of powering a rotary pizza stone for a cooking session.

It is also an object of some but not necessarily all embodiments of the present invention to provide a portable pizza oven that is relatively light, compact, and capable of being used safely on a table top surface.

It is also an object of some but not necessarily all embodiments of the present invention to provide a portable pizza oven that is able to generate and sustain the high temperatures required for cooking pizza. In this regard, some embodiments of the invention may utilize an arrangement using multiple gas-powered burners, including one or more bottom burners and a curved back burner, that is capable of efficiently generating very even and high temperatures.

It is also an object of some but not necessarily all embodiments of the present invention to provide a portable pizza oven that improves the ease with which a pizza may be quickly and evenly cooked to have a crisp outer crust without burning. In this regard, some embodiments may use the combination of one or more bottom burners and a curved back burner with or without a reflector to cook both inner and outer crust portions to reach a finished state simultaneously.

It is also an object of some but not necessarily all embodiments of the present invention to provide a portable pizza oven that is esthetically pleasing and mimics the look and feel of a traditional brick oven.

It is also an object of some but not necessarily all embodiments of the present invention to provide a portable pizza oven that is designed to be used safely outdoors without generating excessively high outer surface temperatures. At the same time, some but not all embodiments of the present invention may be easily cleaned. To achieve this goal, some embodiments may include a housing including an upper portion that pivots away from a lower portion to allow access to the interior of the oven for cleaning.

It is another object of some, but not necessarily all embodiments of the present invention to provide a portable pizza oven that is capable of more quickly rebounding to a desired cooking temperature when tasked with heating a series of cold items, one after the other. To achieve this goal, some embodiments of the present invention may include the aforenoted multiple gas-powered burner arrangement.

### SUMMARY OF EMBODIMENTS OF THE INVENTION

Responsive to the foregoing challenges, Applicant has developed an innovative portable baking oven having one or more of the features described in the detailed description.

Applicant has further developed an innovative oven comprising: a housing defining a baking chamber and a baking chamber opening, said baking chamber opening having a width dimension and a height dimension, wherein the width dimension is greater than the height dimension, and wherein said baking chamber opening is of sufficient size to allow a baking item to pass therethrough; a circular metal pan disposed within the baking chamber, said metal pan having a plurality of openings provided about a central axis wherein said central axis extends in a direction that is substantially parallel to the height dimension of the baking chamber opening; a baking stone supported by said metal pan; a gas-powered burner disposed within the baking chamber below the circular metal pan; and a mechanically wound spring motor operatively connected to the circular metal pan, said spring motor adapted to rotate the circular metal pan about the central axis.

Applicant has further developed an innovative oven comprising: a housing defining a baking chamber and a baking chamber opening, wherein said baking chamber opening has a width dimension and a height dimension, wherein the width dimension is greater than the height dimension, wherein the housing includes an upper portion, a lower portion, wherein said baking chamber opening is entirely defined by said upper portion, and wherein said baking chamber opening is of sufficient size to allow a baking item to pass therethrough; at least one hinge connecting the upper portion to the lower portion, wherein said at least one hinge is adapted to permit the upper portion to pivot away from the lower portion; a circular metal pan disposed within the baking chamber, said metal pan having a plurality of openings provided about a central axis, wherein said central axis extends in a direction that is substantially parallel to the height dimension of the baking chamber opening; a baking stone supported by said metal pan; a gas-powered burner disposed within the baking chamber below the circular metal pan; and a mechanically wound spring motor operatively connected to the circular metal pan, said spring motor adapted to rotate the circular metal pan about the central axis.

Applicant has still further developed an innovative oven comprising: a housing defining a baking chamber and a baking chamber opening, said baking chamber opening having a width dimension and a height dimension, wherein the width dimension is greater than the height dimension, and wherein said baking chamber opening is of sufficient size to allow a baking item to pass therethrough; a circular metal pan disposed within the baking chamber, said metal pan having a plurality of openings provided about a central axis wherein said central axis extends in a direction that is substantially parallel to the height dimension of the baking chamber opening; a baking stone supported by said metal pan; a mechanically wound spring motor operatively connected to the circular metal pan, said spring motor adapted to rotate the circular metal pan about the central axis; and a gas-powered curved back burner disposed within the baking chamber above and behind the circular metal pan relative to the baking chamber opening.

It is to be understood that both the foregoing general description and the following detailed description are exemplary and explanatory only and are not restrictive of the invention as claimed.

### BRIEF DESCRIPTION OF THE DRAWINGS

In order to assist the understanding of this invention, reference will now be made to the appended drawings, in which like reference characters refer to like elements. The drawings are exemplary only and should not be construed as limiting the invention.

FIG. 1 is a front view a portable oven in accordance with embodiments of the invention.

FIG. 2 is a front view a portable oven in accordance with alternative embodiments of the invention.

FIG. 3 is a front cross-sectional view of a portable oven in accordance with embodiments of the invention.

FIG. 4 is a perspective view of a mechanically wound spring motor in accordance with embodiments of the invention.

FIG. 5 is perspective cross-sectional view of a mechanically wound spring motor in accordance with embodiments of the invention.

FIG. 6 is a side view of a portable oven in accordance with embodiments of the invention.

FIG. 7 is a front perspective view of a portable oven shown with upper and lower portions in an open, unlocked, or cleaning position in accordance with embodiments of the invention.

### DETAILED DESCRIPTION OF EMBODIMENTS OF THE INVENTION

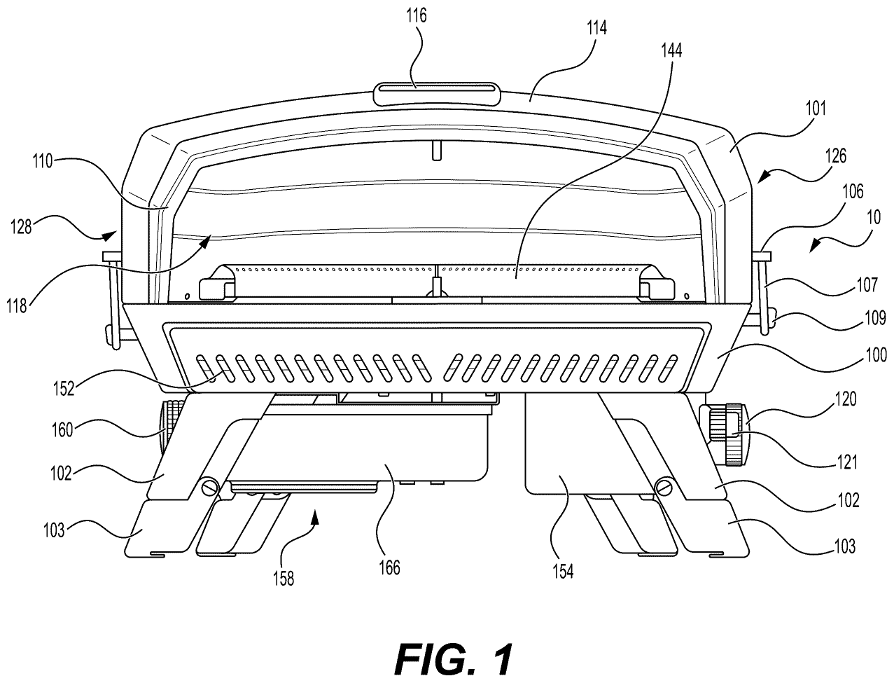

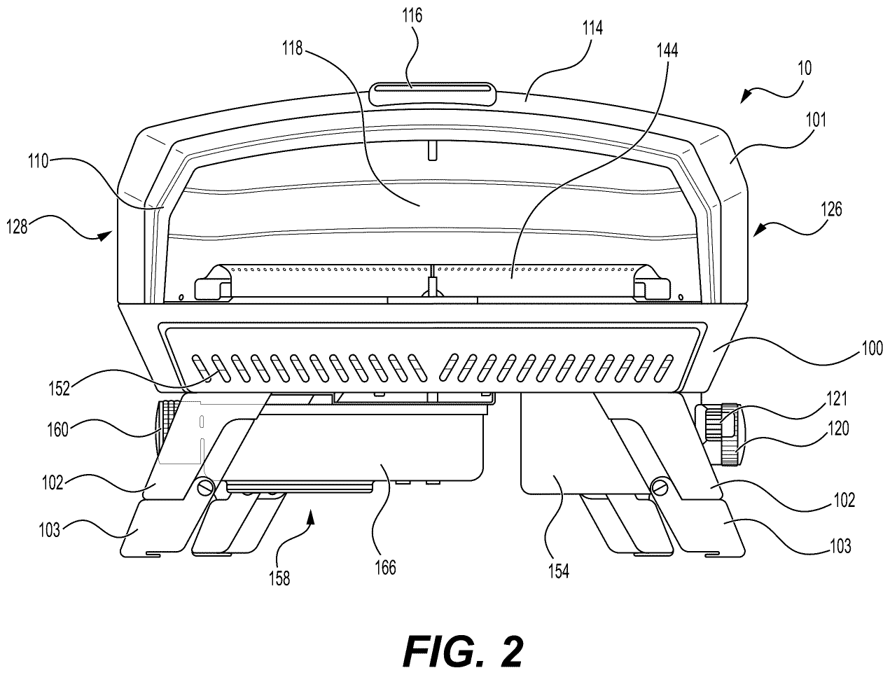

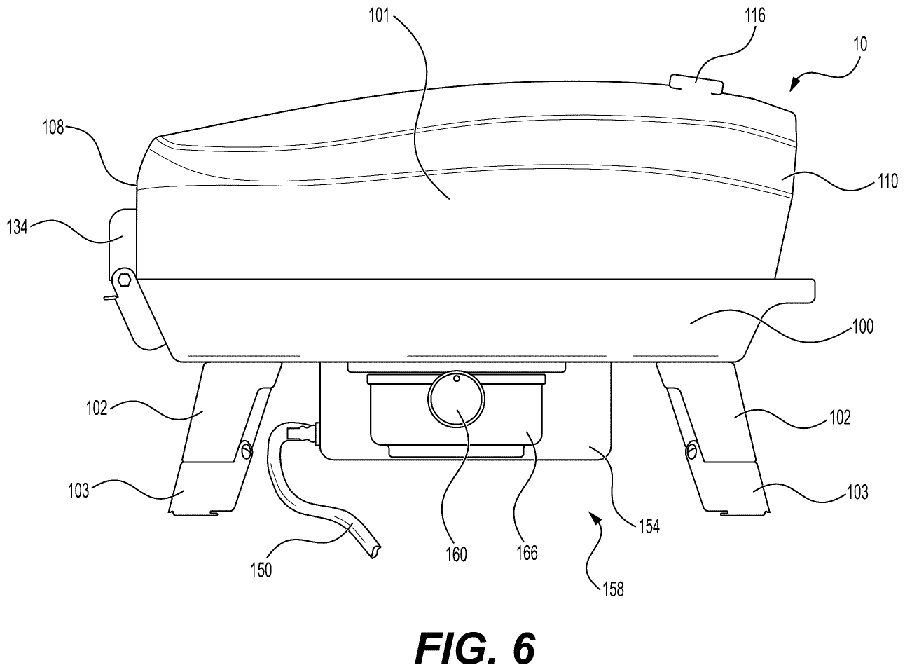

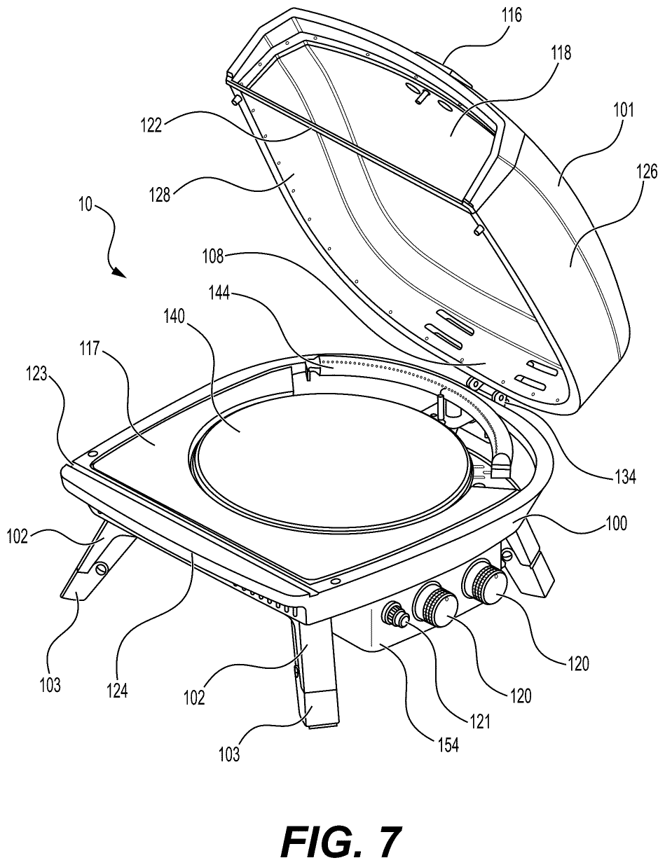

Reference will now be made in detail to embodiments of the present invention, examples of which are illustrated in the accompanying drawings. With reference to FIGS. 1, 2, 3, 6 and 7, the outer surface of a portable or tabletop oven 10 may include an oven housing including a lower portion 100 and an upper portion 101 preferably constructed largely or entirely of stainless steel and/or other formed metal(s). The housing lower portion 100 may be supported on an underside by four spaced upper feet 102 and lower feet 103 combinations. Each upper foot 102 and lower foot 103 pair may be pivotally connected together so as to selectively provide a short or long configuration. When pivoted inwardly about an intervening hinge, the lower foot 103 may nest securely within a notched recess provided on the surface of the upper foot 102. A housing topside 114 may be gently curved or bowed from side-to-side with a central peak. The topside 114 may support a temperature indicator 116 near (as shown) or on an upper front lip portion of the housing. The rear walls 108 of the oven housing may be connected by one or more hinges 134.

A lower front lip 122 may be integral with and extend across a lower portion of the housing upper portion 101 thereby defining the lower boundary of a baking chamber opening 118. The upper front lip 124 may extend across the front of the housing lower portion 100 and may extend a predetermined distance, preferably in the range of 0.5 to 1.5 inches, and more preferably about 0.75 inches, beyond the outer edge of the lower front lip 122 of the housing upper portion 101 when the upper portion is pivoted fully downward into a closed position. The lower front lip 122 may be configured to be received cleanly within a recess 123 extending across the upper front lip 124 of the housing lower portion 100 so that the upper surface of the lower front lip is flush with the upper surface of the upper front lip. The lower front lip 122 and not the upper front lip 124 frames and defines the lower boundary of a baking chamber opening 118. The baking chamber opening 118 may have a width dimension that is greater than its height dimension. The baking chamber opening 118 may also be of sufficient size to easily allow a baking item, such as a pizza, to pass therethrough into the baking chamber (i.e., the interior of the housing upper portion 101 and lower portion 100. A baking stone 140, discussed in more detail below, may be provided within the baking chamber.

The front face 110 and the upper front lip 124, may be gently curved or bowed from side-to-side in a complimentary fashion with a central peak. One or more control knobs 120 and an ignitor button 121 may be provided at a manifold housing 154 below the housing lower portion 100. A fuel connection hose 150 may extend from the manifold housing 154. The fuel connection hose 150 may be coupled to a one pound gas canister connector (not shown) and/or a twenty pound gas canister connector (not shown).

The housing lower portion 100 and the housing upper portion 101 may be connected together with one or more hinges 134. In a preferred embodiment, a single hinge 134 is employed. The hinge 134 may permit the housing upper portion 101 to pivot away from the housing lower portion 101. One or more bushings may be provided along the mating side edges of either or both of the lower portion 100 and the upper portion 101 to provide a cushion between the two portions when they are closed towards one another.

The left side wall 128 and the right side wall 126 of the upper portion 101 each may have a U-shaped lid strap mount 106 fastened thereto. The forward left and right sides of the lower portion 100 each may have a lid strap catch 109 extending away from the lower portion directly below the lid strap mounts 106. A flexible lid strap 107 may be permanently connected to each of the lid strap mounts 106. Each lid strap 107 may include an opening adapted to receive and removably connect to a corresponding lid strap catch 109. The lid straps 107 may be constructed of stretchable material that may be pulled down and over the lid strap catches 109 so that when the upper portion 101 and the lower portion 100 are in a collapsed position, the upper portion and lower portion are held securely together in a clamshell fashion.

The housing lower portion 100 may include one or more gas-powered bottom burners 190 disposed within the housing lower portion 100 below the baking stone 140 and removable tray 117. A back burner 144 may be provided above the removable tray 117 between the baking stone 140 and the rear wall 108. The one or more bottom burners 190 and the back burner 144 may be configured to disperse and burn propane gas, natural gas, or the like under the control of separate control knobs 120. The back burner 144 preferably may have a gently curved shape when viewed from above that is complimentary to the curved shape of the baking stone 140. Alternatively, the back burner 144 may have, and/or include, some other shape, such as a linear shape. The back burner 144 may be positioned relative to the baking stone 140 to provide a flame backdrop when viewed from the front face 110.

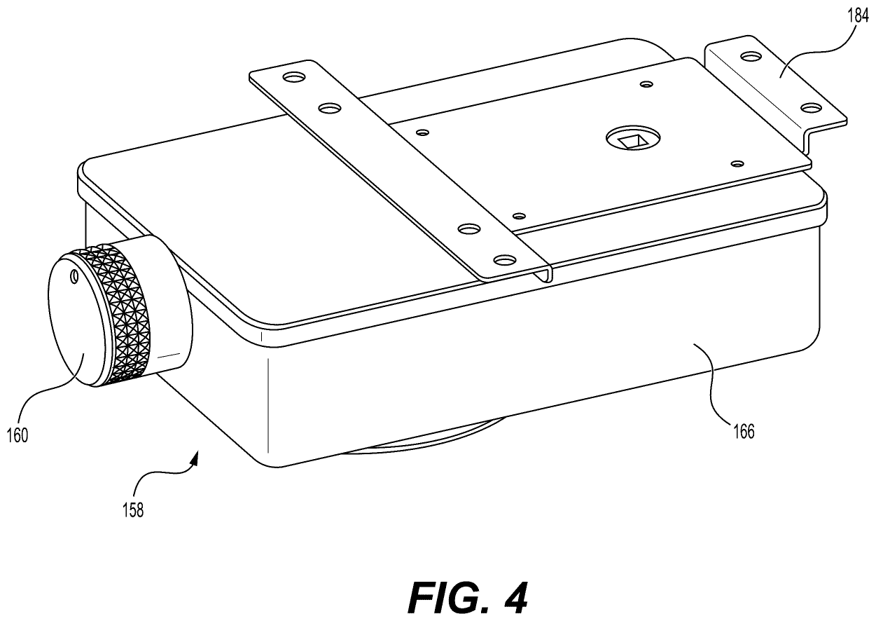

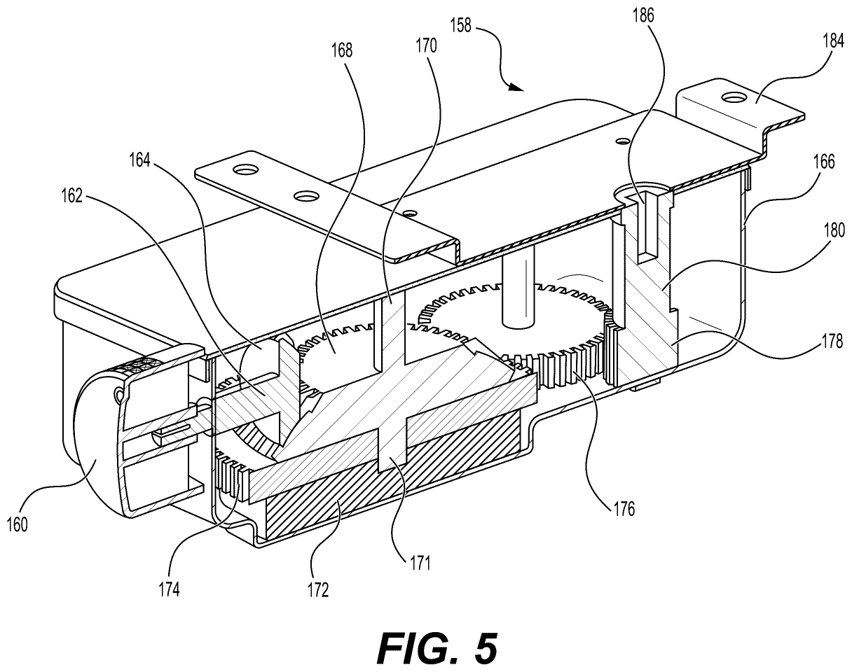

With reference to FIGS. 1-7, a mechanically wound spring motor 158 may be mounted below the oven housing lower portion 100. One or more motor connectors, such as a bracket 184, for example, may secure the spring motor housing 166 of the spring motor 158 to the housing lower portion 100. The one or more motor connectors 184 may be configured to space the spring motor 158 from the burner elements in the lower portion 100 so that a layer of cooling air may be maintained between the rotary motor and the burners. The spring motor 158 preferably may be geared to rotate a drive shaft assembly 182 that is connected to a circular metal pan 165 supporting the baking stone 140. The drive shaft assembly 182 may define the central axis for the baking oven 10. The spring motor 158 may rotate the metal pan 165 and baking stone 140 at a speed predetermined to provide optimal baking for a pizza.

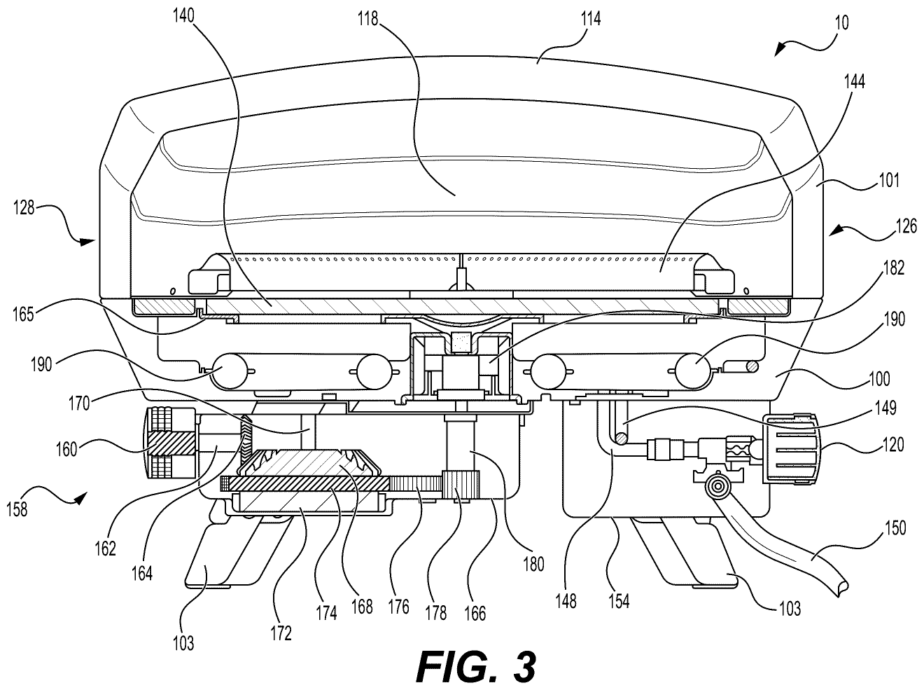

With reference to FIGS. 3, 4 and 5, the spring motor 158 may include an outer housing 166 having a top opening and a side opening provided therein. A vertical bevel gear shaft 162 may extend through the side opening in the housing 166. A winding knob 160 may be fitted onto the end of the vertical bevel gear shaft 162 that extends beyond the housing 166. The opposite end of the vertical bevel gear shaft 162 may be integrally formed with, or attached to, a vertical bevel gear 164. The teeth of the vertical bevel gear 164 may engage complimentary teeth of a horizontal bevel gear 168. The ratio of the number of teeth on the horizontal bevel gear 168 to the number of teeth on the vertical bevel gear 164 may be greater than 2:1 and preferably greater than 3:1. An upper bevel gear shaft 170 may extend upward from the center of the horizontal bevel gear 168, and a lower bevel gear shaft 171 may extend downward from the center of the horizontal bevel gear through the center of an outer transfer gear 174 into a constant force spring (e.g., a helical spring) 172. The combination of the horizontal bevel gear 164, the outer transfer gear 174 and the helical spring 172 may be pinned together between the top and bottom of the housing 166 to rotate as a single unit. The teeth of the outer transfer gear 174 may engage the teeth of an inner transfer gear 176, which in turn may engage the teeth of a central gear 178. The central gear 178 may include a central shaft 180 extending upward to the top opening in the housing 166. A central shaft recess 186 may be formed in the center of the central shaft 180. The drive shaft assembly 182 may include a lower extension that engages the central shaft recess 186 thus permitting the central shaft 180 to rotate the drive shaft assembly.

The winding knob 160 may be used to wind the helical spring 172 into a compressed or tensioned state where it stores potential energy. The gradual unwinding of the helical spring 172 results in rotation of the interlocking gears in the overall system, which in turn rotates the metal pan 165 and the baking stone 140 during a baking operation. It is appreciated that the helical spring 172 and horizontal bevel gear 174 combination may incorporate an intervening clutch assembly so that the horizontal bevel gear 174 only rotates when the helical spring is unwinding, and does not rotate when the winding knob is rotated to load the helical spring into a state of tension.

With renewed reference to FIGS. 1-7, the circular metal pan 165 may include an outer upward extending lip adapted to securely hold the baking stone 140, and a plurality of generally trapezoidal shaped openings formed in the metal pan central planar surface. The one or more bottom burners 190 may be disposed within the housing lower portion 100 such that the burners register with the trapezoidal openings provided in the metal pan 165 as it rotates to allow heat to be directly applied to the baking stone 140. The number and size of the pan openings may be such that when the metal pan 165 is rotated at a constant speed, the one or more bottom burners 190 disposed below the metal pan are exposed to the baking stone 140 supported by the metal pan more than half of the time that the spring motor 158 is rotating the metal pan.

The baking stone 140 may be disposed generally centrally between the rear wall 108, the lower front lip 122, the right side wall 126, and the left side wall 128 of the oven 10. The baking stone 140 may be provided in the open space adjacent to the removable tray 117. Preferably the baking stone 140 may have a diameter of about 14 inches and more preferably of about 16 inches. Preferably the baking chamber volume is sufficient to permit items having a greater vertical dimension than that of a pizza to be cooked within it.

The one or more bottom burners 190 and the back burner 144 may be connected to first and second gas manifolds 148 and 149, which in turn may be connected to individual gas valve/regulators having separate control knobs 120. The control knobs 120 may be used to control the heat output/fuel supply to the one or more bottom burners 190 and the back burner 144. The fuel connection hose 150 may connect to the first and second gas manifolds 148 and 149. An ignitor 121 for the back burner 144 and the one or more bottom burners 190 may be disposed on the side of the housing lower portion 100. The back burner 144 preferably has gas openings on the top, more preferably on the top side closer in proximity to the baking stone 140 than to the rear wall 108. The one or more bottom burners 190, in conjunction with the rotating baking stone 140, may heat the bottom of the baking stone evenly while the back burner 144 heats the upper part of the baking chamber to cook the top of a pizza at the same time.

As will be understood by those skilled in the art, the invention may be embodied in other specific forms without departing from the spirit or essential characteristics thereof. The elements described above are provided as illustrative examples for implementing the invention. One skilled in the art will recognize that many other implementations are possible without departing from the present invention as recited in the claims. For example, the shapes and sizes of various elements of the embodiments of the invention may be changed without departing from the intended scope of the invention. Accordingly, the disclosure of the present invention is intended to be illustrative, but not limiting, of the scope of the invention. It is intended that the present invention cover all such modifications and variations of the invention, provided they come within the scope of the appended claims and their equivalents.

What is claimed:

1. An oven comprising:
a housing defining a baking chamber and a baking chamber opening, said baking chamber opening having a width dimension and a height dimension, wherein the width dimension is greater than the height dimension, and wherein said baking chamber opening is of sufficient size to allow a baking item to pass therethrough;
a support pan disposed within the baking chamber, said support pan having a plurality of openings provided about a central axis wherein said central axis extends in a direction that is substantially parallel to the height dimension of the baking chamber opening;
a baking stone supported by said support pan;
a gas-powered burner disposed within the baking chamber below the support pan; and
a mechanically wound spring motor operatively connected to the support pan, said motor configured to rotate the support pan about the central axis.

2. The oven of claim 1 wherein the mechanically wound spring motor includes:
a vertical bevel gear; and
a horizontal bevel gear intermeshed with the vertical bevel gear.

3. The oven of claim 2 wherein the mechanically wound spring motor includes:
a helical spring operatively connected to the horizontal bevel gear.

4. The oven of claim 1 wherein the mechanically wound spring motor includes:
a helical spring operatively connected to a gear assembly.

5. The oven of claim 1 wherein the mechanically wound spring motor includes:
an outer housing;
a winding knob disposed outside of the outer housing;
a gear assembly operatively connected to the winding knob;
a spring operatively connected to the gear assembly; and
a geared shaft operatively connected to the gear assembly and the support pan.

6. The oven of claim 1 wherein the housing comprises:
an upper portion defining an entirety of the baking chamber opening;
a lower portion connected to the mechanically wound spring motor; and
at least one hinge connecting the upper portion to the lower portion, said at least one hinge adapted to permit the upper portion to pivot away from the lower portion.

7. The oven of claim 4 wherein the at least one hinge includes a biasing element adapted to maintain the upper portion in a pivoted away position relative to the lower portion.

8. The oven of claim 1 wherein the gas-powered burner includes first and second gas manifolds.

9. The oven of claim 7 wherein the housing comprises:
an upper portion defining an entirety of the baking chamber opening;
a lower portion connected to the mechanically wound spring motor; and
at least one hinge connecting the upper portion to the lower portion, said at least one hinge adapted to permit the upper portion to pivot away from the lower portion.

10. The oven of claim 9 wherein the at least one hinge includes a biasing element adapted to maintain the upper portion in a pivoted away position relative to the lower portion.

11. The oven of claim 9 further comprising a gas-powered curved back burner disposed within the baking chamber above and behind the support pan relative to the baking chamber opening.

12. The oven of claim 1 further comprising a gas-powered curved back burner disposed within the baking chamber above and behind the support pan relative to the baking chamber opening.

13. The oven of claim 12 further comprising a single gas valve connected to both the gas-powered burner and the gas-powered curved back burner.

14. An oven comprising:
a housing defining a baking chamber and a baking chamber opening, wherein said baking chamber opening has a width dimension and a height dimension, wherein the width dimension is greater than the height dimension, wherein said baking chamber opening is of sufficient size to allow a baking item to pass therethrough;
a baking stone disposed in the housing; and
a mechanically wound spring motor configured to rotate the baking stone.

15. The oven of claim 14 further comprising a gas-powered curved back burner disposed within the baking chamber above and behind the baking stone relative to the baking chamber opening.

16. The oven of claim 14 wherein the mechanically wound spring motor includes:
a vertical bevel gear; and
a horizontal bevel gear intermeshed with the vertical bevel gear.

17. The oven of claim 16 wherein the mechanically wound spring motor includes:
a helical spring operatively connected to the horizontal bevel gear.

18. The oven of claim 14 wherein the mechanically wound spring motor includes:
a helical spring operatively connected to a gear assembly.

19. The oven of claim 14 wherein the mechanically wound spring motor includes:
an outer housing;
a winding knob disposed outside of the outer housing;
a gear assembly operatively connected to the winding knob;
a spring operatively connected to the gear assembly; and
a geared shaft operatively connected to the gear assembly and the support pan.

20. An oven comprising:
a housing defining a baking chamber and a baking chamber opening, wherein said baking chamber opening has a width dimension and a height dimension, wherein the width dimension is greater than the height dimension, wherein the housing includes an upper portion and a lower portion, wherein said baking chamber opening is entirely defined by said upper portion, and wherein said baking chamber opening is of sufficient size to allow a baking item to pass therethrough;
at least one hinge is adapted to permit the upper portion to pivot away from the lower portion and wherein said baking chamber opening is of sufficient size to allow a baking item to pass therethrough when the upper portion is fully pivoted toward the lower portion;
a circular pan disposed within the baking chamber;
a baking stone supported by said pan;
a gas-powered bottom burner disposed within the baking chamber below the pan; and
a mechanically wound spring motor operatively connected to the pan, said motor configured to rotate the pan about a central axis.
